(19) United States
(12) Patent Application Publication
(10) Pub. No.: US 2023/0409952 A1
(43) Pub. Date: Dec. 21, 2023

(54) IMPROVEMENTS TO QUANTUM ENTANGLEMENT GENERATION

(71) Applicant: BRITISH TELECOMMUNICATIONS PUBLIC LIMITED COMPANY, London (GB)

(72) Inventor: Ryan PARKER, London (GB)

(21) Appl. No.: 18/248,281

(22) PCT Filed: Sep. 17, 2021
(86) PCT No.: PCT/EP2021/075639

§ 371 Date: Apr. 7, 2023

(30) Foreign Application Priority Data
Oct. 8, 2020 (GB) 2015974.5

(51) Int. Cl. G06N 10/60

(52) U.S. Cl. CPC G06N 10/60

(57) ABSTRACT

There is herein provided a method of determining whether one or more pairs of qubits are quantum-entangled, the method comprising: performing a Bell State measurement on a first qubit, the first qubit being from a first multi-partite quantum-entangled state and a second qubit, the second qubit being from a second multi-partite quantum-entangled state, performing a Bell Inequality test on a third qubit, the third qubit being from the first multipartite quantum-entangled state and a fourth qubit, the fourth qubit being from the second quantum-entangled state, determining, using an outcome of the Bell Inequality test, whether a fifth qubit, the fifth qubit being from the first multipartite quantum-entangled state is quantum-entangled with a sixth qubit, the sixth qubit being from the second multi-partite quantum-entangled state.

Various quantum technologies require a source of quantum-entangled qubits in order to operate. Such technologies include QKD (Quantum Key Distribution), quantum coin-flipping, quantum untrusted dice and distributed quantum computing.

A known technique for generating entangled qubits is to perform a Bell State measurement on two qubits, where each of the qubits is from a respective bipartite quantum-entangled state. If the Bell State measurement is successful, the two qubits will be entangled. Furthermore, this entanglement will “transfer” to the remaining qubits in the two bipartite quantum-entangled states, i.e. the remaining qubit in the first bipartite quantum-entangled state will be entangled with the remaining qubit in the second bipartite quantum-entangled state. However, Bell State measurements are not always successful. It would be desirable, for the above-mentioned technologies, to provide a reliable stream of quantum-entangled qubits.

It is possible to check whether the remaining qubits in the two states are successfully entangled by performing a Bell Inequality test. However, the act of performing the test destroys the quantum state that was present.

It is desirable to address this and/or any other disadvantages of the prior art.

According to a first aspect of the invention there is disclosed a method of determining whether one or more pairs of qubits are quantum-entangled, the method comprising: Performing a Bell State measurement on
(i) a first qubit, the first qubit being from a first multi-partite quantum-entangled state and
(ii) a second qubit, the second qubit being from a second multi-partite quantum-entangled state, Performing a Bell Inequality test on
(iii) a third qubit, the third qubit being from the first multipartite quantum-entangled state and
(iv) a fourth qubit, the fourth qubit being from the second quantum-entangled state,

Determining, using an outcome of the Bell Inequality test, whether a fifth qubit, the fifth qubit being from the first multipartite quantum-entangled state is quantum-entangled with a sixth qubit, the sixth qubit being from the second multi-partite quantum-entangled state.

This method has an advantage over the prior art that, if the outcome of the Bell Inequality Test is that the Bell Inequality is violated, this verifies that the fifth and sixth qubits are successfully quantum-entangled.

The first multi-partite quantum-entangled state and the second multi-partite quantum-entangled state may each contain three or more quantum-entangled qubits. The first and second multi-partite quantum-entangled states may be GHZ states. In presently preferred embodiments the first and second multi-partite quantum-entangled states are tripartite states.

The first multi-partite quantum-entangled state may be located in a first node and the second multi-partite quantum-entangled state may be located in a second node. The first and/or second nodes may be nodes in a telecommunications network.

The method may further comprise, at the first node, transmitting the first qubit. The Bell State measurement may be performed on the first qubit after this transmission. The method may further comprise, at the second node, transmitting the second qubit. The Bell State measurement may be performed on the second qubit after this transmission. The Bell State measurement may be performed at a third node, separate from the first and second nodes. The Bell State measurement may comprise mixing the first qubit with the second qubit. This may comprise passing the first and second qubits through a mixing beam splitter, which may be a 50:50 beam splitter and may have two outputs. The method may further comprise measuring one or more of the outputs of the mixing step. This may comprise splitting one or more of the outputs of the mixing beam splitter and detecting one or more of the resulting split beams. This may be performed using one or more single photon detectors. The step of splitting one or more of the outputs of the mixing beam splitter may be performed using a polarising beam splitter. If each of the outputs of the mixing beam splitter cause a detector to detect a photon, this may indicate that the first and second qubits are successfully entangled. In some embodiments the Bell State measurement is performed on board a satellite.

The method may further comprise, at the first node, transmitting the third qubit. The Bell Inequality test may be performed on the third qubit after this transmission and may be performed within the first node. The method may further comprise, at the second node, transmitting the fourth qubit. The Bell Inequality test may be performed on the fourth qubit after this transmission and may be performed within the second node. The Bell Inequality test may comprise splitting the qubit and measuring each of the split outputs. The splitting may be performed with a polarising beam splitter and the measuring may be performed with single-photon detectors. If a photon from one of the split outputs from each of the two Bell Inequality tests (i.e. on the third qubit and the fourth qubit) are detected, this may indicate that the Bell Inequality has been violated. This means that the third and fourth qubits are successfully entangled. This in turn indicates that the fifth and sixth qubits are successfully entangled.

Multiple iterations of the method according to the invention may be performed. Preferably more than 1000 iterations are performed. The method may comprise determining if the Bell Inequality is violated for more than a threshold proportion the iterations performed. If so, this may indicate that the third and fourth qubits (and hence the fifth and sixth qubits) are successfully entangled.

The method may further comprise transmitting the fifth qubit to a first external entity. The method may further comprise transmitting the sixth qubit to a second external entity. The first and second external entities may use the fifth and sixth qubits to perform QKD or other quantum communication protocols.

According to a second aspect of the invention there is disclosed an arrangement for determining whether one or more pairs of qubits are quantum-entangled, the arrangement comprising: Bell State measurement apparatus for performing a Bell State measurement on
(i) a first qubit, the first qubit being from a first multi-partite quantum-entangled state from the first node and
(ii) a second qubit, the second qubit being from a second multi-partite quantum-entangled state; Bell Inequality test apparatus for performing a Bell Inequality test on
(iii) a third qubit, the third qubit being from the first multipartite quantum-entangled state and
(iv) a fourth qubit, the fourth qubit being from the second multi-partite quantum-entangled state;

A determiner for determining, using an outcome of the Bell Inequality test, whether a fifth qubit, the fifth qubit being from the first multipartite quantum-entangled state, is quantum-entangled with a sixth qubit, the sixth qubit being from the second multi-partite quantum-entangled state.

The first node may have an output for outputting the fifth qubit. The second node may have an output for outputting the sixth qubit.

Embodiments of the invention will now be described in detail, for illustration only, and with reference to the appended drawings, in which:

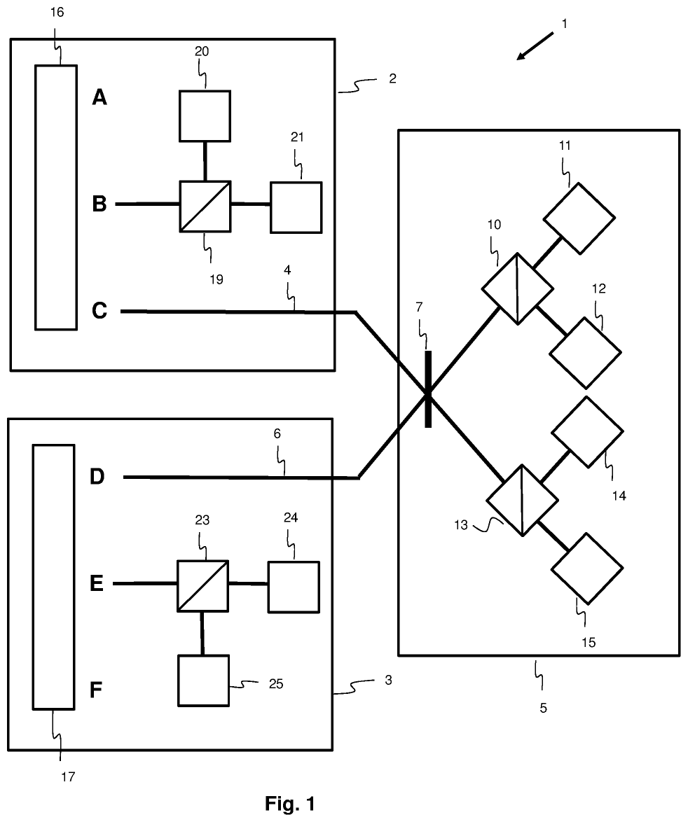

FIG. 1 is a schematic drawing of the arrangement in accordance with the invention;

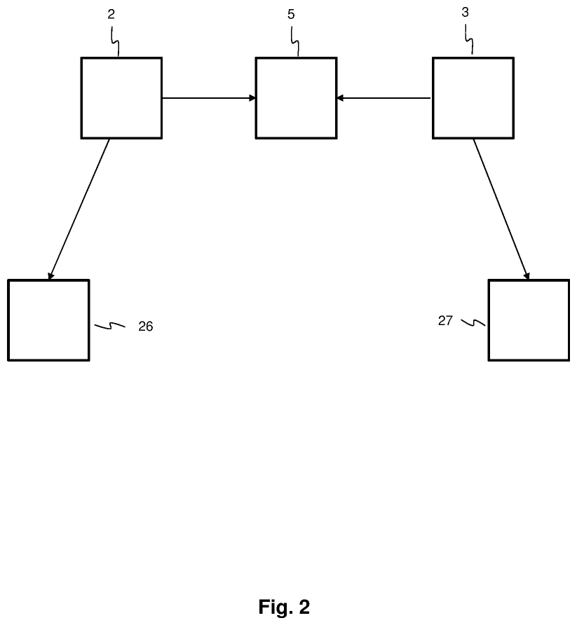

FIG. 2 is a schematic drawing of the arrangement in accordance with the invention including nodes for receiving the entangled qubits;

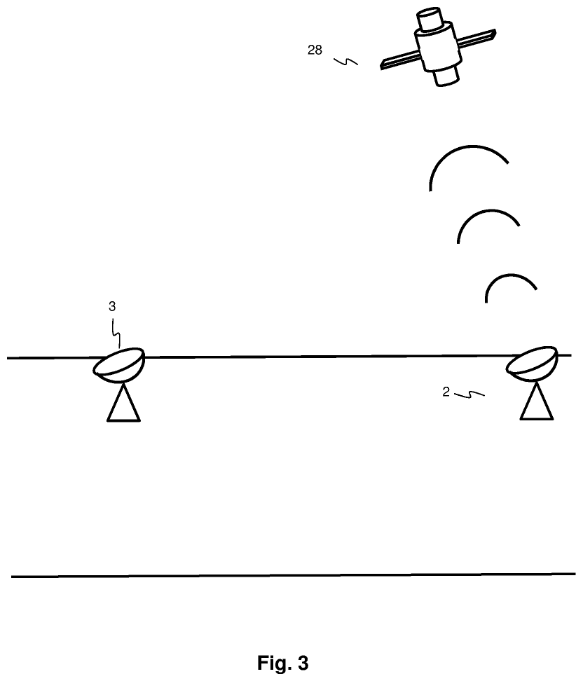

FIG. 3 a schematic drawing of a further embodiment according to the invention.

FIG. 1 shows an optical arrangement 1 containing two quantum nodes: Alice 2; and Bob 3. Alice 2 and Bob 3 are exchanges within a telecommunications network. Alice 2 and Bob 3 each possess a respective tripartite quantum state. A tripartite quantum state is a state containing three quantum-entangled qubits. In this case the respective tripartite states are polarisation-entangled. Quantum entanglement is a concept that is familiar to those skilled in the art and so will not be explained here. A tripartite state, along with any such state containing more than three entangled qubits is known as a GHZ (Greenberger-Horne-Zeilinger) state. The three quantum-entangled qubits in Alice's tripartite state are labelled in FIG. 1 as A, B and C respectively. The three quantum-entangled qubits in Bob's tripartite state are labelled in FIG. 1 as D, E and F respectively. Alice 2 and Bob 3 have respective GHZ entanglement sources 16, 17 for generating the GHZ states.

Alice 2 sends one qubit of her tripartite state, specifically qubit C, via optical fibre 4 to unit 5. Bob 3 sends one qubit of his tripartite state, specifically qubit D, via optical fibre 6 to unit 5. At unit 5, a Bell state measurement is performed on qubits C and D, which causes them to become quantum-entangled together. The Bell state measurement involves passing the qubits C and D into a 50:50 beam-splitter 7 which “mixes” them. This causes qubits C and D to become entangled.

Beam splitter 7 has first and second optical fibre outputs. One of the entangled qubits C and D will be output from the first output and the other from the second output. The first output leads to a polarising beam splitter 10, the two outputs of which lead to respective single photon detectors 11, 12. The qubit (i.e. C or D) enters polarising beam splitter 10 which splits the quantum state of the qubit between the two outputs. The quantum state of the qubit will collapse into one of the two detectors 11, 12 at random, causing that detector to detect a qubit (or to “click”, to use a term in the art). The qubit that is output from the second output of beam splitter 7 enters polarising beam splitter 13 which splits the quantum state of the qubit between its two outputs, which lead to detectors 14 and respectively. The quantum state will collapse into one of detectors 14, 15 at random, causing that detector to click. This whole process is known as a Bell State measurement. The result is that Alice's remaining qubits A and B and Bob's remaining qubits E and F are all quantum-entangled together. Put simply, the Bell State measurement causes qubits C and D to become entangled and that entanglement “transfers” to Alice and Bob's remaining qubits.

The Bell State measurement will have been performed successfully if one of detectors 11, 12 clicks and one of detectors 14, 15 also clicks. Which two of the four detectors click gives an indication of which of the four possible Bell States the entangled pair C and D is in. These four possible Bell States are given in Table 1 below.

TABLE 1

| | Detector 11 | Detector 12 | Detector 14 | Detector 15 |
|---|---|---|---|---|
| Bell State 1 | 1 | 0 | 1 | 0 |
| Bell State 2 | 1 | 0 | 0 | 1 |
| Bell State 3 | 0 | 1 | 1 | 0 |
| Bell State 4 | 0 | 1 | 0 | 1 |

In Table 1, an output value of 1 indicates that a detector has clicked and an output value of 0 indicates that a detector has not clicked. As can be seen from Table 1, a successful Bell State measurement can produce four different Bell States, each of which causes a different pair of detectors to click.

Although not shown in the drawings, the Bell State measurement unit 5 communicates the output of the detectors 11, 12, 14 and 15 to Alice 2 and Bob 3.

If the Bell State measurement is successful, each of Alice 2 and Bob 3 then perform a Bell Inequality Test on one of the remaining qubits in their respective GHZ states. In the present example Alice 2 will perform the Bell Inequality test on qubit B and Bob 3 will perform the test on qubit E. Alice 2 transmits qubit B along an optical fibre to polarising beam splitter 19. The two outputs of polarising beam splitter 19 lead to single photon detectors 20 and 21. Polarising beam splitter splits the quantum state of qubit B, which will collapse into one of detectors 20 or 21 at random, causing it to click. Similarly, Bob 3 transmits qubit E along an optical fibre to polarising beam splitter 23. The two outputs of polarising beam splitter 23 lead to single photon detectors 24 and 25. Polarising beam splitter 23 splits the quantum state of qubit E, which will collapse into one of detectors 24 or 25 at random, causing it to click. If both qubit B and qubit E cause a detector to click this indicates that they are entangled. As with qubits C and D, the particular Bell State of qubits B and E can be determined from the outputs of the detectors. Table 2 below shows the different outputs produced by each of the four possible Bell States.

TABLE 2

| | Detector 20 | Detector 21 | Detector 24 | Detector 25 |
|---|---|---|---|---|
| Bell State 1 | 1 | 0 | 1 | 0 |
| Bell State 2 | 1 | 0 | 0 | 1 |
| Bell State 3 | 0 | 1 | 1 | 0 |
| Bell State 4 | 0 | 1 | 0 | 1 |

As in Table 1, in Table 2 an output value of 1 indicates that a detector has clicked and an output value of 0 indicates that a detector has not clicked. Although not shown in the drawings, Alice 2 communicates the output of the detectors 20 and 21 to Bob 3 and Bob 3 communicates the output of detectors 24 and 25 to Alice 2.

Alice 2 and Bob 3 then repeat the process with a large number of further GHZ states. In each case, if the Bell State measurement is successful on qubits C and D, a Bell Inequality test is performed on qubits B and E. If for more than a threshold proportion of the GHZ states, qubits B and E both cause a detector to click, it is determined that Bell's Inequality has been violated. This means that, at least for some of the GHZ states, Alice 2 and Bob's remaining qubits (i.e qubits A and F) are successfully entangled. The larger the amount by which Bell's Inequality has been violated, the larger the proportion of GHZ states having A/F pairs that have been successfully entangled. This verification of entanglement has been achieved without destroying the entanglement of A and F. Furthermore, the Bell State that A and F are in can be determined from the detector readings from qubits C and D and qubits B and E.

FIG. 2 is a schematic view of arrangement of FIG. 1, plus nodes 26 and 27. Nodes 26 and 27 are external to Alice 2 and Bob 3. If it is determined that Bell's Inequality has been violated, as so qubits A and F have been successfully entangled, Alice 2 transmits qubit A to node 26. Bob 3 transmits qubit F to node 27. Nodes 26 and 27 can then use their received qubits, for example to perform quantum key distribution with each other. This would be done, for example, by nodes 26 and 27 each measuring their incoming qubits in a sequence of randomly-chosen basis states and exchanging a list of the basis states used. This technique would be familiar to those skilled in the art. Other uses include quantum coin-flipping, quantum untrusted dice and distributed quantum computing. Nodes 26 and 27 need not trust each other, nor do they need to trust Alice 2 and Bob 3. This is because, although Alice 2 and Bob 3 can determine the Bell State of the entangled qubit pair A and F, Alice 2 and Bob 3 do not know the exact quantum states of the individual qubits, i.e. the quantum state of A and the quantum state of F. To do so would require eavesdropping on qubits A and F. If Alice 2 or Bob 3 (or anyone else) were to eavesdrop on the qubits A and F as they pass to nodes 26, 27, the entanglement between qubits A and F would be destroyed. This will result in decoherence in the channel, which would be detectable by nodes 26 and 27.

FIG. 3 is a schematic view of an arrangement according to the invention in which Alice 2 and Bob 3 are remote from each other. Unit 5 is located aboard a satellite 28. The process followed in this embodiment is the same as described in relation to FIG. 1, except that the qubits C and D are transmitted, from Alice 2 and Bob 3 respectively, through free space (i.e. the earth's atmosphere) to unit 5 aboard satellite 28. In this embodiment Alice 2 transmits qubit C when satellite 28 is located within range. The satellite 28 continues its orbit and, when it comes within range of Bob 3, Bob 3 transmits qubit D to the satellite 28. The Bell State measurement is performed on C and D in the manner described in relation to FIG. 1. As with the embodiment relating to FIG. 1, Alice 2 and Bob 3 perform the Bell Inequality Test locally. Again, if the Bell Inequality is found to be violated, qubits A and F are successfully entangled and can be used for the purposes listed above. In this embodiment Alice 2 and Bob 3 can be on opposite sides of the globe. Alice 2 and Bob 3 can each provide their respective qubit to a local user in the manner described above, meaning that two users on opposite sides of the globe share an entangled pair of qubits.

Although it is not shown in the figures, GHZ states containing more than three qubits could be used instead. This would result in more than one pair of entangled qubits the entanglement of which has been verified.

1. A method of determining whether one or more pairs of qubits are quantum-entangled, the method comprising:
performing a Bell State measurement on
(i) a first qubit, the first qubit being from a first multi-partite quantum-entangled state and
(ii) a second qubit, the second qubit being from a second multi-partite quantum-entangled state,
performing a Bell Inequality test on
(iii) a third qubit, the third qubit being from the first multipartite quantum-entangled state and
(iv) a fourth qubit, the fourth qubit being from the second quantum-entangled state,
determining, using an outcome of the Bell Inequality test, whether a fifth qubit, the fifth qubit being from the first multipartite quantum-entangled state is quantum-entangled with a sixth qubit, the sixth qubit being from the second multi-partite quantum-entangled state.

2. A method according to claim 1, wherein the first multi-partite quantum-entangled state and the second multi-partite quantum-entangled state each contain three quantum-entangled qubits.

3. A method according to claim 1, wherein the first multi-partite quantum-entangled state is located in a first node and the second multi-partite quantum-entangled state is located in a second node.

4. A method according to claim 3, wherein the Bell State measurement is performed at a third node, separate to the first and second nodes.

5. A method according to claim 4, wherein the third node is on board a satellite.

6. A method according to claim 1, wherein more than 1000 iterations of the method are performed.

7. A method according to claim 6, further comprising determining if the Bell Inequality is violated for more than a threshold proportion the iterations performed.

8. A method according to claim 1, the method further comprising transmitting the fifth qubit to a first external entity and transmitting the sixth qubit to a second external entity.

9. An arrangement for determining whether one or more pairs of qubits are quantum-entangled, the arrangement comprising:
Bell State measurement apparatus for performing a Bell State measurement on
(i) a first qubit, the first qubit being from a first multi-partite quantum-entangled state from the first node and
(ii) a second qubit, the second qubit being from a second multi-partite quantum-entangled state;
Bell Inequality test apparatus for performing a Bell Inequality test on
(iii) a third qubit, the third qubit being from the first multipartite quantum-entangled state and
(iv) a fourth qubit, the fourth qubit being from the second multi-partite quantum-entangled state;
a determiner for determining, using an outcome of the Bell Inequality test, whether a fifth qubit, the fifth qubit being from the first multipartite quantum-entangled state, is quantum-entangled with a sixth qubit, the sixth qubit being from the second multi-partite quantum-entangled state.
